(19) United States
(12) Patent Application Publication
(10) Pub. No.: US 2025/0092611 A1
(43) Pub. Date: Mar. 20, 2025

(54) ACCESS MATS

(71) Applicants: Jean-Maire Najm, Okotoks (CA); John Malley, Okotoks (CA)

(72) Inventors: Jean-Maire Najm, Okotoks (CA); John Malley, Okotoks (CA)

(21) Appl. No.: 18/469,013

(22) Filed: Sep. 18, 2023

(51) Int. Cl. E01C 5/00; B32B 7/08; B32B 9/02

(52) U.S. Cl. CPC E01C 5/008; B32B 7/08; B32B 9/02; B32B 2250/03; B32B 2250/05; B32B 2307/514; B32B 2471/04

(57) ABSTRACT

An access mat configured to be superposed terrain so as to assist vehicles and machinery to traverse thereacross. The sustainable access mat includes a body wherein the body is rectangular in shape having a first end and a second end with opposing lateral edges. The body is manufactured from a first layer having anti-slip upper surface, a second layer and a third layer wherein the second layer is intermediate the first layer and third layer. The layers of the body are manufactured from bamboo and the orientation of the bamboo strand direction of each adjacent layer is perpendicular to the adjacent layer. The second layer and third layer further have notches formed in the first end and second end thereof. Tab members are provided to facilitate operable coupling of adjacent access mats. The first end perimeter edge and second end perimeter edge of the first layer extends over the notches.

### FIELD OF THE INVENTION

The present invention relates generally to access mats, more specifically but not by way of limitation, an access mat that is deployed for environments such as but not limited to pipeline, mining and oilfields, construction, power generation, power transmission, telecommunications, public services (transportation and infrastructure) wherein unstable soil conditions inhibit vehicle and machinery access without additional assistance from an access mat and wherein the access mat of the present invention is operably coupled with additional access mats. Furthermore, the access mat of the present invention is manufactured from ecologically sustainable materials and environmentally friendly resins.

### BACKGROUND

As is known in the art, industries such as but not limited to the oil and gas industry, pipelines, power generation and telecommunications have significant infrastructure deployed in remote areas. By way of example but not limitation, an oil drilling rig is often located in a remote area that does not have paved infrastructure providing access thereto. Typically, temporary roadways are created to access the area where the oil drilling rig is located utilizing bulldozers and other similar equipment. While a roadway is cleared for equipment, the soil terrain is not covered with concrete or similar infrastructure providing an improved ability to traverse vehicles and machinery across the terrain in order to access the oil drilling rig.

Conventional techniques deploy elements such as but not limited to wood planks or other similar material that are placed on top of the terrain in areas that may have a lot of mud or are unstable so a vehicle may traverse across the wood planks, Deployment of these planks is cumbersome and requires significant manpower and time. Another issue with conventional techniques is the materials they are manufactured from often have some water absorption which is undesirable and weakens the plank over time and use thereof. Lastly, current technology does not deploy access mats or planks that are manufactured from a sustainable material.

Accordingly, there is a need for an access mat that is configured to be deployed over a terrain so as to assist in vehicles and machinery accessing a desired location wherein the access mat is manufactured from strong lightweight nonabsorbent material and further is linkable to additional access mats of the present invention.

### SUMMARY OF THE INVENTION

It is the object of the present invention to provide an access mat that is configured to be superposed terrain in order to permit vehicles to traverse across to access a desired location wherein the access mat of the present invention includes a body that is rectangular in shape.

Another object of the present invention is to provide an access mat that is operable to facilitate traversing of machinery and vehicles thereacross for access to a specific location wherein the body of the present invention includes a first layer, a second layer and a third layer.

A further object of the present invention is to provide an access mat that is configured to be superposed terrain in order to permit vehicles to traverse across to access a desired location wherein the first layer further includes an anti-slip material layer superposed on the upper surface thereof.

Yet a further object of the present invention is to provide an access mat that is operable to facilitate traversing of machinery and vehicles thereacross for access to a specific location wherein the perimeter end edges of the first layer extend beyond the perimeter end edges of the second layer and third layer.

Still another object of the present invention is to provide an access mat that is configured to be superposed terrain in order to permit vehicles to traverse across to access a desired location wherein the perimeter end edge of the first end of the body of the second layer and third layer have notches formed therein.

An additional object of the present invention is to provide an access mat that is operable to facilitate traversing of machinery and vehicles thereacross for access to a specific location wherein the perimeter end edge of the second end of the body of the second layer and third layer have tab members formed therein.

Yet a further object of the present invention is to provide an access mat that is configured to be superposed terrain in order to permit vehicles to traverse across to access a desired location wherein the first layer, second layer and third layer of the body are manufactured from stranded bamboo wherein the directional orientation of the bamboo strands for each layer are opposing.

Another object of the present invention is to provide an access mat that is operable to facilitate traversing of machinery and vehicles thereacross for access to a specific location wherein each layer of the body comprises of three sublayers of bamboo strand.

Still a further object of the present invention is to provide an access mat that is configured to be superposed terrain in order to permit vehicles to traverse across to access a desired location wherein the layers of the body are mechanically secured to each other as well as chemically bonded.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is an exploded diagram of the body of the present invention; and

FIG. 2 is a top view of the body of the present invention; and

FIG. 3 is a cross-section view of the body of the present invention.

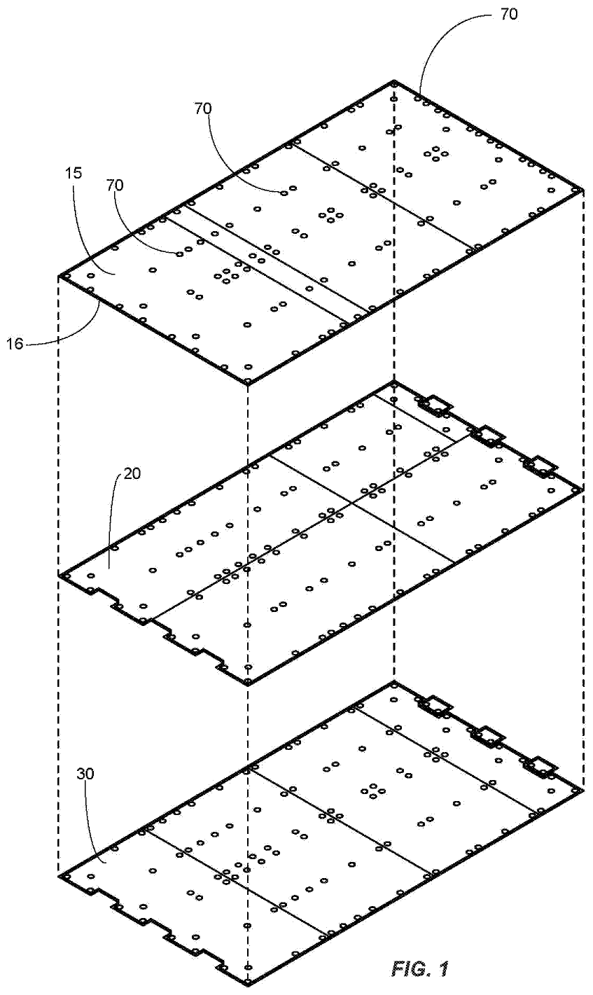

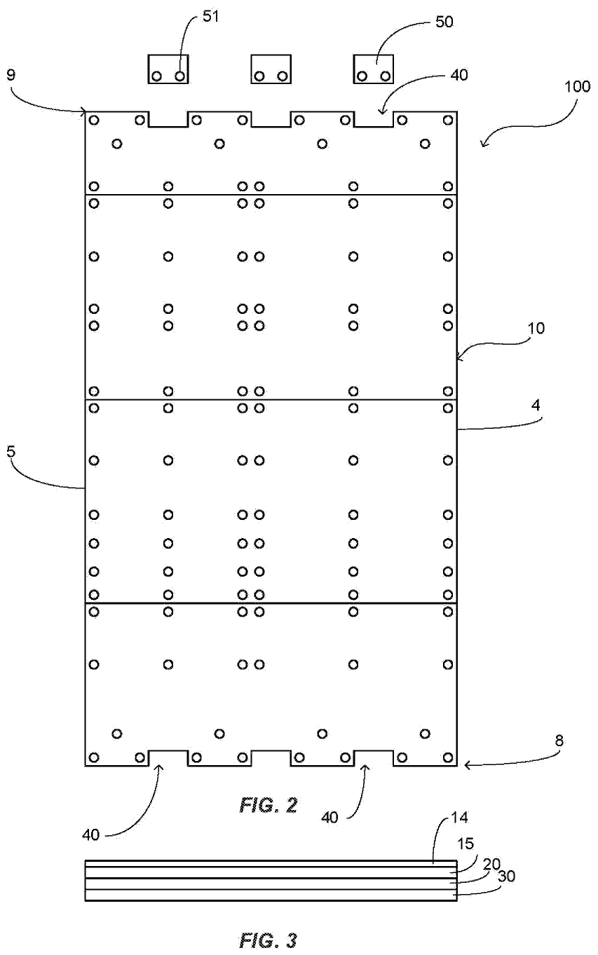

### DETAILED DESCRIPTION

Referring now to the drawings submitted herewith, wherein various elements depicted therein are not necessarily drawn to scale and wherein through the views and figures like elements are referenced with identical reference numerals, there is illustrated an access mat 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the access mat 100 includes a body 10. The body 10 is comprised of a first layer 15, a second layer 20 and a third layer 30. The second layer 20 is intermediate the first layer 15 and third layer 30. In preferred embodiment of the access mat 100 the first layer 15, second layer 20 and third layer 30 are manufactured from bamboo. More specifically, each of the layers of the body 10 are comprised of three sublayers of bamboo wherein each layer of bamboo is oriented wherein the strands of the bamboo are perpendicular to the strands of bamboo of the adjacent sublayer. By way of example but not limitation, the first sublayer of the first layer 15 is oriented so the bamboo strands extend longitudinally along the body 10 in between the first end perimeter edge 8 and the second end perimeter edge 9. The adjacent sublayer is oriented so the bamboo strands are oriented to extend between the first lateral edge 4 and second lateral edge 5. The sublayers are infused with resin or similar material and are pressed to form the layers of the body 10 discussed herein. While three sublayers are employed to manufacture the layers of the body 10 in a preferred embodiment, it is contemplated within the scope of the present invention that the layers of the body 10 could be comprised of more or less than three sublayers.

The first perimeter edge 16 and second perimeter edge 17 of the first layer 15 are positioned so as to extend beyond the first perimeter edge 8 and second perimeter edge 9 of the second layer 20 and third layer 30. The aforementioned position of the first perimeter edge 16 and second perimeter edge 17 of the first layer 15 provide an abutment against an adjacent access mat 100 that is operable coupled to the access mat 100. The access mat 100 as is further discussed herein is configured to be operably coupled to a plurality of access mats 100 in order to create a pathway or travel path to a desired location across terrain that may not be suitable for a vehicle or machinery to travers across. Employing a first perimeter edge 16 and second perimeter edge 17 of the first layer 15 as discussed herein provides a gapless transition between the adjacent perimeter edges of adjacent access mats 100.

The first layer 15 has superposed thereon a traction surface 14. The traction surface 14 is operable to provide an increase in the coefficient of friction with the access mat 100 with vehicle tires so as to inhibit the slipping thereof during traversing across the traction surface 14. In a preferred embodiment of the present invention the traction surface 14 is a combination of a particle matter such as but not limited to crushed rubber, crushed glass or aggregate and resin. It should be understood within the scope of the present invention that the various alternate materials could be employed to manufacture the traction surface 14 in order to achieve the desired objective discussed herein.

The first perimeter edge 8 and second perimeter 9 of the second layer 20 and third layer 30 include a plurality of notches 40 formed therein. The notches 40 are formed utilizing suitable techniques and are configured to be operably coupled with the tab members 50. Tab members 50 are manufactured from the same material as the body 10 and are employed to mechanically couple adjacent access mats 100. While three notches 40 are illustrated herein along the first perimeter edge 8 and second perimeter 9, it is contemplated within the scope of the present invention that more or less then three notches 40 could be employed. Furthermore, while a particular shape of the notch 40 is illustrated herein, it should be understood within the scope of the present invention that the notch 40 could be formed in alternate shape so as to mateably couple with a tab member 50 provided in a similar shape. The tab member 50 includes apertures 51 wherein the apertures 51 are configured to have mechanical fasteners journaled therethrough in order to facilitate securing of the tab members 50 to the body 10. While tab members 50 are illustrated herein as a technique to operably couple adjacent access mats 100, it is contemplated within the scope of the present invention that the access mats 100 could be operably coupled employing various alternate techniques.

The body 10 includes a plurality of apertures 70 journaled through the first layer 15, second layer 20 and third layer 30 wherein all of the apertures 70 are axially aligned. The apertures 70 are arranged in a pattern to ensure a capability of handling load distribution as heavy machinery traverses across the access mat 100. In a preferred embodiment of the present invention the apertures 70 are arranged in six linear rows between the first perimeter edge 8 and second perimeter edge 9.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An access mat configured to be superposed a terrain to assist vehicles and machinery to traverse thereacross wherein the access mat comprises:
a body, said body having a first layer, a second layer and a third layer, said second layer of said body being intermediate said first layer and said third layer, said body having a first end and a second end, said second layer having a first end perimeter edge, said second layer having a second end perimeter edge, said third layer having a first end perimeter edge being aligned with the first end perimeter edge of said second layer, said third layer having a second end perimeter edge being aligned with the second end perimeter edge of said second layer, said first layer having a first end perimeter edge and a second end perimeter edge, wherein said first end perimeter edge of said first layer extends beyond said first end perimeter edge of said second layer and wherein said second end perimeter edge of said first layer extends beyond said second end perimeter edge of said second layer; and
wherein said first end of said body includes at least one notch and wherein said second end of said body includes at least one notch.

2. The access mat configured to be superposed a terrain to assist vehicles and machinery to traverse thereacross as recited in claim 1, wherein said first layer of said body is comprised of three sublayers, said three sublayers being manufactured from bamboo, wherein each of said three sublayers of said first layer being oriented such that a direction of bamboo strands is perpendicular to an adjacent sublayer.

3. The access mat configured to be superposed a terrain to assist vehicles and machinery to traverse thereacross as recited in claim 2, and further including tab members, said tab members being mateably shaped with said at least one notch being operable to be inserted thereinto to facilitate operable coupling of an adjacent access mat.

4. The access mat configured to be superposed a terrain to assist vehicles and machinery to traverse thereacross as recited in claim 3, wherein said body includes a plurality of apertures journaled therethrough, said plurality of apertures configured to have mechanical fasteners journaled therethrough.

5. The access mat configured to be superposed a terrain to assist vehicles and machinery to traverse thereacross as recited in claim 4, and further including an anti-slip surface, said anti-slip surface being superposed an upper surface of the first layer of the body.

6. The access mat configured to be superposed a terrain to assist vehicles and machinery to traverse thereacross as recited in claim 5, wherein said second layer of said body is comprised of three sublayers, said three sublayers of said second layer being manufactured from bamboo, wherein each of said three sublayers of said second layer being oriented such that a direction of bamboo strands is perpendicular to an adjacent sublayer.

7. The access mat configured to be superposed a terrain to assist vehicles and machinery to traverse thereacross as recited in claim 6, wherein said plurality of apertures on said body are arranged in six linear rows intermediate said first end and said second end of said body.

8. The access mat configured to be superposed a terrain to assist vehicles and machinery to traverse thereacross as recited in claim 7, wherein said third layer of said body is comprised of three sublayers, said three sublayers of said third layer being manufactured from bamboo, wherein each of said three sublayers of said third layer being oriented such that a direction of bamboo strands is perpendicular to an adjacent sublayer.

9. The access mat configured to be superposed a terrain to assist vehicles and machinery to traverse thereacross as recited in claim 8, wherein said tab members further include two apertures formed therein, said two apertures configured to have a mechanical fastener journaled therethrough.
